(19) United States
(12) Patent Application Publication
(10) Pub. No.: US 2009/0157741 A1
(43) Pub. Date: Jun. 18, 2009

(54) DATA OBJECT COPY/PASTE TRANSFER METHOD AND APPARATUS

(75) Inventors: Yuan Cheng, Beijing (CN); Yue Ma, Beijing (CN); Min Qu, Beijing (CN); Hai F. Zhang, Beijing (CN)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 12/332,667

(22) Filed: Dec. 11, 2008

(30) Foreign Application Priority Data
Dec. 12, 2007 (EP) 200710193895.5

(51) Int. Cl. G06F 17/30

(52) U.S. Cl. 707/103 Y; 707/E17.044

(57) ABSTRACT

The present invention provides a solution of transferring a data object between files through copy/paste, in which not only the filtered data object which is adapted to the format and/or function of a destination file is explicitly written to the destination file, but also the original data object information is implicitly written to the destination file, and the map relationship between them is established, so that the whole original information of the transferred data object is reserved during the transfer between files. In subsequent copy/paste operations, the user may choose to use the original data object corresponding to the data object in the transfer of the data object or not based on the actual situation and particular needs, so that the problem of information loss in the process of transferring a data object between files through copy/paste operation is solved effectively.

### FIELD OF THE INVENTION

The present invention relates to data transfer between files and, more particularly, to a method and apparatus of transferring data objects between files through the copy/paste operation.

### BACKGROUND OF THE INVENTION

With the development of information technology, users may create a variety of files using different computer applications, in order to, for example, record, save and edit information. An operation frequently performed by users is to transfer some data information (hereinafter referred to as “data objects”), which is saved in a file, from this file to another or from one location to another in this file. The copy/paste operation is the most commonly used means for transferring data objects and is also a function supported by the overwhelming majority of computer applications.

Specifically, since different applications might have their own file formats, there would be information lost when data objects are being transferred between files of different applications.

FIG. 1 schematically depicts a typical inter-file data object transfer mechanism 100 in the prior art. As shown in FIG. 1, a first application 110 and a second application 120 run with the support of an operating system 130. First application 110 created a first file 112, and second application 120 created a second file 122. During an operation, it is intended that a data object 114 (e.g. text, an image, a table, and the like) contained in first file 112 which serves as a source file will be transferred to second file 122 which serves as a destination file. Data transfer between these files is implemented by the process of copying (or cutting) and then pasting. In the copy operation, selected data object 114 is read out from first file 112 and is temporarily stored to a specific data buffer area named clipboard and managed by operating system 130. In the paste operation next, stored data object 114 is read out from the clipboard and written to a designated location in second file 122.

When first file 112 and second file 122 have different file formats, data object 114 of first file 112 needs to be format-filtered during the copy/paste operation, in order to form a data object 114′ which conforms to the file format of second file 122. Specifically, before data object 114 stored in the clipboard is written to second file 122, a data format (if there is) contained in this data object and not supported by second file 122 needs to be filtered out. Hence, there would be information loss in data object 114′ in relation to data object 114. Consider the following instance: a user wants to transfer a selected table (data object 114) in a Lotus Spreadsheet file (first file 112) to a Microsoft Excel file (second file 122). With the copy/paste method in the prior art, although all data information of the selected table is copied to the clipboard, since the Microsoft Excel file does not support some formats and/or functions of the Lotus Spreadsheet file, information corresponding to formats and/or functions which are not supported by the Microsoft Excel file will be filtered out during the formation of a data object (data object 114′) corresponding to the Microsoft Excel file.

It is to be understood that information loss due to the difference in data format is unrecoverable. For example, when the user wants to transfer data object 114′ in second file 122 back to first file 112, information missing in data object 114′ in relation to source data object 114 cannot be retrieved. Furthermore, such information loss might be deteriorated with the performance of subsequent copy/paste operation. For example, when the user hopes to re-copy data object 114′, which was pasted to second file 122, to other file (not shown), if the format of the new destination file does not support some formats and/or functions of second file 122, then corresponding data object information will still be filtered out and thus lost during the paste operation.

To avoid data loss during copy/paste, one solution is to reserve the original content of a transferred data object in the clipboard. For example, when data object 114 is transferred from first file 112 to second file 122, the whole original content of data object 114 is still reserved in the clipboard even after copy/paste operation. However, this practice has obvious problems. Firstly, the clipboard has limited capacity and would not support unlimited data storage, and new data might flush previously stored data. Secondly, the clipboard is usually a storage area of an internal memory, and all data in the clipboard will be lost when operating system 130 stops running (for example, when the computer shuts down). Furthermore, the clipboard per se cannot be shared between different computers or between different operating systems on a computer. Therefore, when a file is created on one computer and edited on another or when a file is created under one operating system of a computer and edited under another operating system of the same computer, information would still be lost due to the data copy/paste transfer.

### SUMMARY OF THE INVENTION

To overcome the deficiencies in the prior art, the present invention provides an improved data copy/paste method and an apparatus thereof, which can reserve the original content of a transferred data object in the process of transferring data between files through the copy/paste operation, thereby keeping data consistency and integrity.

According to an aspect of the present invention, there is provided a method of copying a data object. The method comprises the steps of: selecting a data object from a file; when there is an original data object corresponding to the data object in the file, writing the data object to the clipboard or writing the original data object to the clipboard at least responsive to the selection of a user, wherein the original data object is mapped to the data object as implicit data of the file.

According to another aspect of the present invention, there is provided a method of pasting a data object. The method comprises the steps of: archiving a data object in the clipboard as an original data object; filtering the data object in order to make it conform to the format and/or functionality requirement of a file; explicitly writing the filtered data object to the file, and implicitly writing the original data object to the file, wherein the original data object is mapped to the data object as implicit data of the file.

According to a further aspect of the present invention, there is provided a file editor which may implement the copy and/or paste method of the present invention.

According to a still further aspect of the present invention, there is provided a corresponding computer program product.

According to the inter-file data object transfer solution of the present invention, not only the filtered data object which is adapted to the format and/or function of a destination file is explicitly written to the destination file, but also the original data object information is implicitly written to the destination file, and the map relationship between them is established, so that the whole original information of the transferred data object is reserved during the transfer between files. In subsequent copy/paste operations, the user may choose to use the original data object corresponding to the data object in the transfer of the data object or not based on the actual situation and particular needs, so that the problem of information loss in the process of transferring a data object between files through copy/paste operation is solved effectively.

### BRIEF DESCRIPTION ON THE DRAWINGS

To better understand the features and advantages of the present invention, a detailed description will be given to the principles and illustrative embodiments of the present invention, when taken in conjunction with the accompanying drawings in which:

FIG. 1 schematically depicts a typical inter-file data object transfer mechanism in the prior art;

FIG. 2 schematically depicts an inter-file data object transfer mechanism according to an embodiment of the present invention;

FIG. 3 depicts a map table for establishing map relationships between data objects and their original formats in a file according to an embodiment of the present invention;

FIG. 4 depicts a processing flowchart of copy operation performed to a data object according to an illustrative embodiment of the present invention;

FIG. 5 depicts a processing flowchart of paste operation performed to a data object according to an illustrative embodiment of the present invention;

FIG. 6 is a flowchart depicting edition operation performed to a data object according to an illustrative embodiment of the present invention; and

FIG. 7 schematically depicts a functional block diagram of a general-purpose computer system in which an embodiment according to the present invention may be implemented.

### DESCRIPTION OF THE PREFERRED EMBODIMENTS

A detailed description will be given to the principles and illustrative embodiments of the present invention, when taken in conjunction with the accompanying drawings. If possible, like or similar reference numerals designate the same or similar parts throughout the accompanying drawings and description.

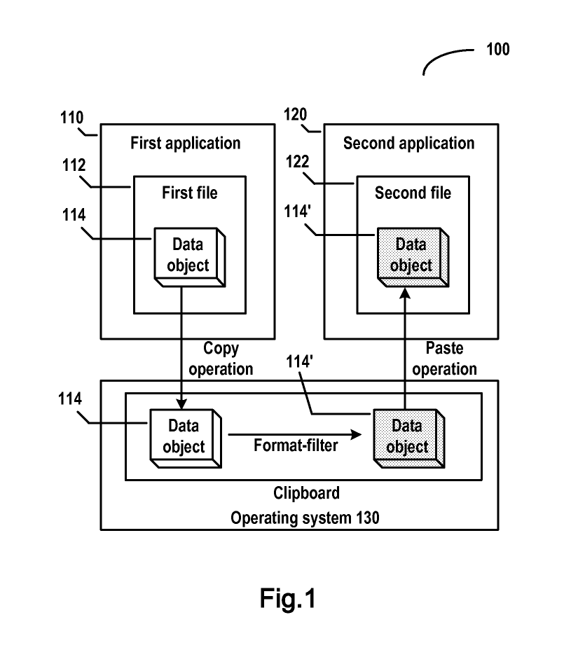

FIG. 1 schematically depicts a typical inter-file data object transfer mechanism in the prior art. As FIG. 1 has been described in detail in the Background of the Invention, description thereof is hereby omitted.

As described previously, information would be lost when a data object is being transferred between files of different types created by different applications, and such information loss is unrecoverable for this data object. To solve this problem, the present application proposes an improved data copy/paste method and an apparatus thereof, which can reserve the original content of a copied data object when data is being transferred between files through copy/paste operation, thereby keeping data consistency and integrity.

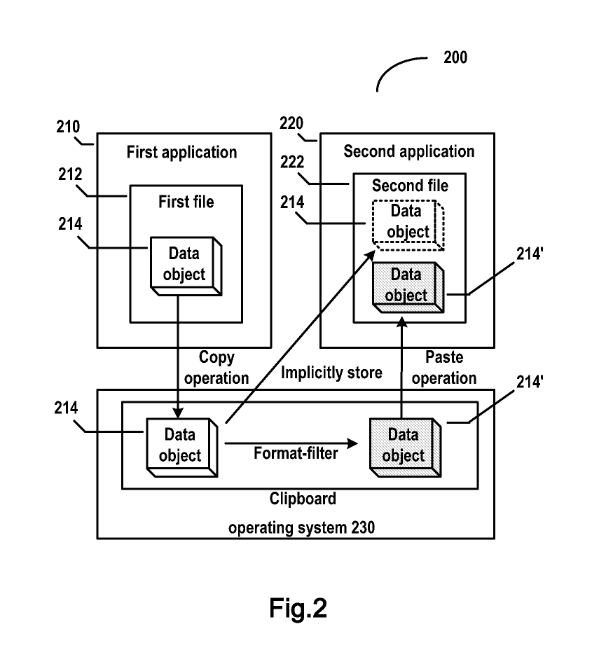

FIG. 2 schematically depicts an inter-file data object transfer mechanism 200 according to the present invention.

As shown in FIG. 2, a first application 210 and a second application 220 run with the support of an operating system 230. First application 210 created a first file 212, and second application 220 created a second file 222. In an operation, a user hopes to transfer a data object 214 (e.g. text, an image, a table, and the like) contained in first file 212 which serves as a source file to second file 222 which serves as a destination file. First, the user selects from first file 212 data object 214 to be copied. After the user inputs a copy request, selected data object 214 is read out from first file 212 and stored into the clipboard. According to an embodiment of the present invention, the whole original data information of copied data object 214 in the clipboard is backed up during copy operation (before format filtering is performed). In response to the user's paste request, format filtering is performed to data object 214 so that a filtered data object 214′ conforms to format and/or functionality requirements of second file 222 which serves as the destination file. It is to be understood that, like a solution in the prior art, the backup and format filtering may be implemented in, for example, the clipboard or any other available memory space. Next, backup data object 214 and data object 214′ which was subjected to the format filtering are simultaneously written to second file 222 which serves as the destination file. Preferably, data object 214′ which is adapted to formats and/or functions of second file 222 is explicitly written to second file 222, and backup data object which contains the whole original data is implicitly written to second file 222. In this manner, data object 214 of first file 212 is transferred to second file 222 through copy/paste.

Although second file 222 only displays filtered data object 214′ which conforms to its formats and/or functions, it stores information of the original data object (i.e. data object 214) corresponding to this data object. According to the embodiment of the present invention, when the user hopes to use this data object once again, for example, re-transfers data object 214′ from second file 222 to a next destination file through copy/paste operation, he may use backup data object 214 which was implicitly stored in second file 222, thereby avoiding data loss due to times of data transfer between files. In a possible example, the user might need to transfer data object 214′ in second file 222 to a next destination file (not shown) through copy/paste operation. In response to the user's copy request, the user may be prompted to choose to copy current data object 214′ or to copy original data object 214 corresponding to current data object 214′. If the user chooses to copy original data object 214 corresponding to current data object 214′, data object 214 implicitly stored is read out from second file 222 and placed in the clipboard. Similarly, the whole original data information of copied data object 214 in the clipboard is backed up. Response to the user's paste request, format filtering is performed to data object 214, in order to make the filtered data object (not shown) conform to format and/or functionality requirement of the present destination file. Next, co-existing backup data object 214 and the format-filtered data object are simultaneously written to the present destination file. It is seen that according to the embodiment of the present invention, data will not be lost even if the data object has been transferred, several times, between files through copy/paste.

In an implementation, the user, of course, may choose to copy the currently selected data object other than its corresponding original data object to the clipboard. At this point, information loss of the data object is under the control of the user.

As a matter of fact, the implementation of the present invention relies on the extension of a file per se. That is to say, a file must support read/write of both explicit data objects and implicit data objects. To carry out the copy/paste mechanism according to the present invention as shown in FIG. 2, a map relationship between an explicit data object and its implicitly saved original data object information in a file must be established. However, it is to be understood to those skilled in the art that such file extension is easily implemented using a variety of extensible file forms. For example, a file is written using the Extensible Markup Language (XML). Even for an inextensible file type created by a specific application (e.g. Word file), the provider may develop a more advanced file type when updating the version of this application, in order to support the technical solution of the present invention. In a word, those skilled in the art may implement file extension, which can support the technical solution of the present invention, in various known manners in the art. The specific matter of file extension does not constitute any limitation on the present invention, and the description thereof is omitted here.

As described previously, a map relationship between an explicitly data object and its implicitly saved original data object information in a file must be established in order to implement the copy/paste mechanism according to the present invention as shown in FIG. 2. For example, this map relationship may be maintained by a map table supported in a file extension format.

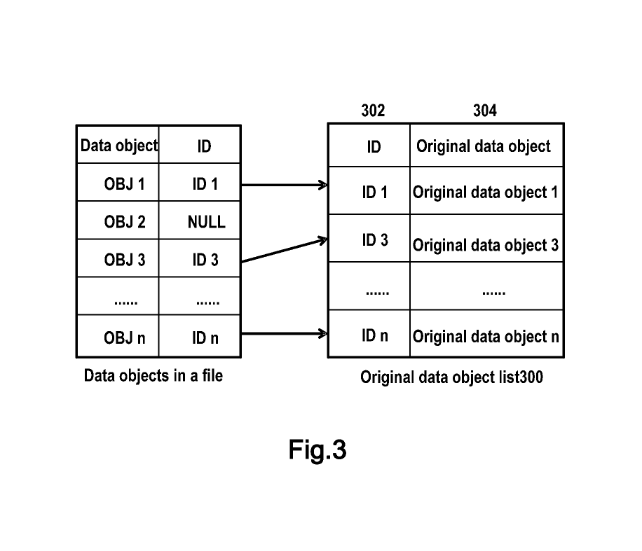

FIG. 3 depicts a mechanism of establishing a map relationship between a data object and its original data object in a file according to an embodiment of the present invention.

As shown in FIG. 3, one implementation is to extra maintain a map table in a file to indicate map relationships between explicit data objects and implicit data objects (original data objects). Of course, map relationships may be maintained in other manners, such as by a database, hash table, array, and the like. In an embodiment, each data object in a file has a property, named ID property herein, which uniquely identifies its original data object information. If a current data object has no corresponding original data object, then its ID property value is NULL. Each file maintains a table 300 named, for example, original data object list. Original data object list 300 at least has two fields: an ID field 302 for recording ID property values of all data objects whose ID property values are non-NULL; and an original data object field 304 for recording the whole original data object information or information's pointer of a data object corresponding to a current ID. In this way, when the user chooses to copy a certain data object, the application may obtain the ID property value of this data object; if the ID property value of this data object is not NULL (that is, this data object has a corresponding original data object), then the application may obtain the whole original data object information of this data object by looking up original data object list 300. Thus, during the implementation of an inter-file data transfer solution according to an embodiment of the present invention, the original data object of a selected data object can be transferred between files according to the user's needs, so that potential data information loss is avoided.

Of course, original data object list 300 may comprise other field in order to maintain more information on an original data object and thereby support a more diversified inter-file data transfer solution. For example, in some case, the user might copy/paste a data object to a file under an operating system (such as Microsoft Windows) and subsequently use this file under another operating system of a different type (such as Linux); or the user might use this file in different applications of the same operating system. Since different applications support different formats, the format of the original data object is usually associated with the operating system and application. This makes the format of an original data object associated with a specific operating system and its applications. This information may also serve as a field. Further, this field may include information identifying the properties and/or states of a data object and its associated original data object, such as whether the data object was modified, the extension property of the data object, and the like.

Referring to the accompanying drawings, a detailed description will be given below to a processing flow of transferring a data object between files through copy/paste operation according to an embodiment of the present invention. To facilitate illustration, the processing flow of transferring a data object between files as described below adopts a map relationship between data objects and their original data objects established by way of original data object list 300 shown in FIG. 3. Therefore, the concrete steps of the processing flow and the performance order of these steps as illustrated here are only illustrative and not limiting the present invention.

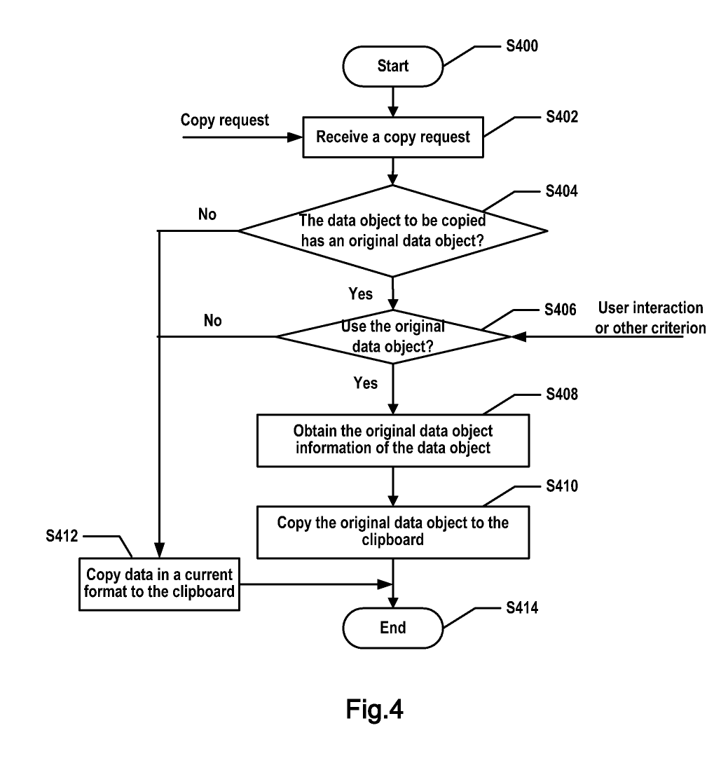

FIG. 4 depicts a processing flowchart of a copy operation performed to a data object according to an illustrative embodiment of the present invention.

The processing flow of a copy operation starts in step S400.

First, in step S402, a copy request from, for example, a user is received, which copy request indicates a data object to be copied.

In step S404, it is determined whether the data object to be copied has an original data object. For example, determination is made by judging whether the ID property value of the data object is NULL or not. In a file, an original data object is stored as implicit data of the file, and this original data object is mapped to a corresponding data object.

If the data object to be copied has an original data object, then the processing goes to step S406, otherwise goes to step S412.

In step S406, it is determined whether the original data object is used to perform subsequent operation, such as paste operation performed in another file. For example, a prompt window may pop up in the user interface to the user to ask the user if he intends to use the original data object of the selected data object. Of course, other predetermined standard may also be used to determine whether the original data object or the explicit data object currently selected is to be used.

If it is determined that the original data object will be used to perform subsequent operation, then the processing goes to step S408, otherwise to step S412.

In step S408, information of the original data object is obtained according to the map relationship between the data object and its corresponding original data object. For example, information of the corresponding original data object is obtained by looking up the original data object field in the original data object list using the obtained ID property value of the data object.

In step S410, the obtained original data object corresponding to the current data object is copied to the clipboard.

In step S412, the current data object is copied to the clipboard.

Finally, the processing flow of copy operation ends in step S414.

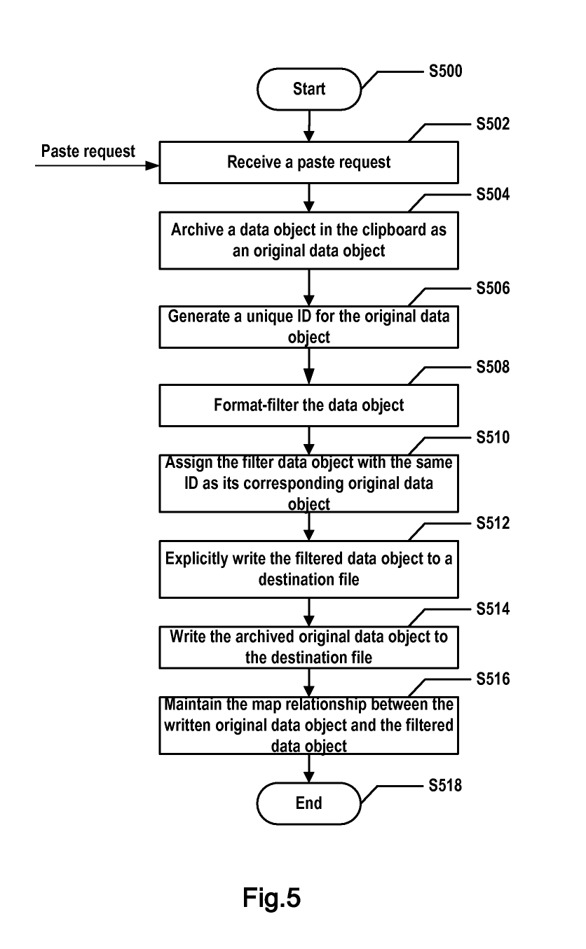

FIG. 5 depicts a processing flowchart of a paste operation performed to a data object according to an illustrative embodiment of the present invention.

First, the processing flow of a paste operation starts in step S500.

In step S502, a paste request from, for example, a use is received.

In step S504, a data object in the clipboard to be pasted is archived as an original data object.

In step S506, an ID uniquely identifying this original data object is generated for the original data object.

In step S508, the data object is format-filtered according to the format and/or functionality requirement of the paste operation destination file, in order to generate the filtered data object.

In step S510, the ID property of the filtered data object is assigned with an ID value uniquely identifying the original data object (i.e. the archived data in step S504). Since the original data object and the format-filtered data object have completely identical IDs, a map relationship between them is established.

In step S512, the filtered data object is explicitly written to the destination file.

In step S514, the original data object (i.e. the archived data in step S504) is implicitly written to the destination file.

In step S516, the map relationship between the filtered data object and the original data object in the file is maintained. In the situation where the map relationship was established by way of the original data object list shown in FIG. 3, a new item is added to the original data object list, and the ID of the original data object and the original data object per se are written to corresponding fields.

Finally, the processing flow of paste operation ends in step S518.

The map relationship between an explicit data object and its implicitly stored original data object in a file needs to be updated when the state of the data object changes, so as to accurately provide the original data object and various related information when the data object is being transferred between files. For example, when an explicit data object in a file is edited (may include modifying and/or deleting) in an application, the map relationship between the explicit data object and its implicit data object (original data object) needs to be maintained correspondingly.

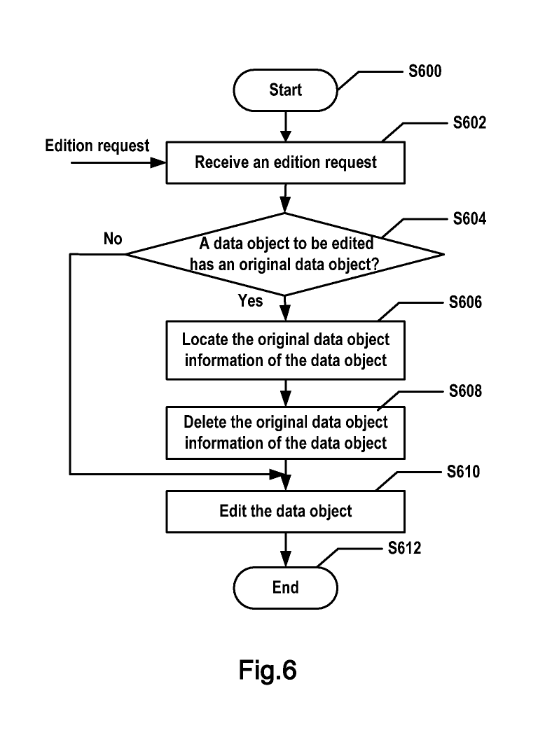

FIG. 6 depicts a processing flowchart of maintaining the map relationship between an explicit data object and an implicit data object (original data object) during edition operation performed to the explicit data object in a file according to an illustrative embodiment of the present invention.

As shown in FIG. 6, the processing flow starts in step S600.

In step S602, a request for editing a data object is received from a user, which request indicates a data object to be edited.

In step S604, it is determined whether the data object to be edited has a corresponding original data object. For example, determination is made by judging whether the ID property value of the data object is NULL or not.

If the data object has a corresponding original data object, then the processing goes to step S606, otherwise to step S610.

In step S606, information of the original data object is located in the file according to the map relationship between the data object and its original format. For example, an item of the original data object in the original data object list is located by using the obtained ID property value of the data object.

In step S608, the original data object is deleted. For example, the deletion of the original data object is implemented by deleting a corresponding item in the original format list and modifying the ID field value of the data object to be edited to be NULL.

In step S610, the data object is edited (may include modifying and/or deleting the data object) in a conventional manner.

Finally, the processing flow ends in step S612.

It is to be understood that when editing the data object in the file, the user may update an item in the map table corresponding to the data object according to given policies. FIG. 6 schematically depicts one of the policies. Other policies may include, for example, when the user edits an explicit data object in a file, tracking operation performed to each explicit data object through extra file extension so that the difference between a current explicit data object and its original data object can be prompted to the user in subsequent use.

It is to be further understood that on the premise of ensuring the accomplishment of the object of the present invention, steps in respective processing flows shown in FIG. 4 to FIG. 6 can be replaced by equivalent steps, and other steps can be added to a flow, and each step can be performed in a different order.

From the foregoing description of the principle and illustrative embodiments of the present invention, it will be recognized that in the inter-file data object transfer solution according to the present invention, not only a filtered data object which conforms to the format and/or function of a destination file is explicitly written to the destination file, but also the original data object information is implicitly written to the destination file, and the map relationship between them is established, so that the whole original information of the transferred data object is reserved during the transfer between files. In subsequent copy/paste, the user may choose to use the original data object in the transfer of the data object or not based on the actual situation and particular needs, so that the problem of information loss in the process of transferring a data object between files through copy/paste operation is solved effectively.

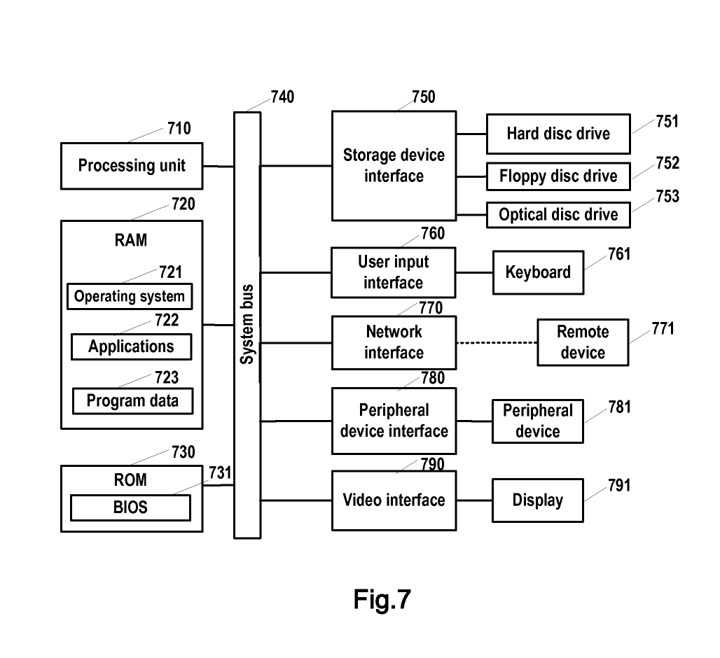

FIG. 7 schematically depicts a functional block diagram of a general-purpose computer system in which an embodiment according to the present invention may be implemented.

The computer system shown in FIG. 7 comprises: a processing unit 710, a RAM (Random Access Memory) 720 on which an operating system 721, an application 722, program data 723 and the like are resident, a ROM (Read-only Memory) 730 on which BIOS is resident, a system bus 740, a storage device interface 750 with which a hard disc drive 751, a floppy disc drive 752 and an optical disc drive 753 are connected, a user input interface 760 with which a keyboard 761 is connected, a network interface 770 for connecting to a remote device 771, a peripheral device interface 780 for connecting to a peripheral device 781, a video interface 790 with which a display 791 is connected. Among these parts, connected with system bus 740 are processing unit 710, RAM 720, ROM 730, storage device interface 750, user input device 760, network interface 770, peripheral device interface 780 and video interface 790.

The functions of each of the components in FIG. 7 are well known in the art, and the structure shown in FIG. 7 is also conventional. Some components shown in FIG. 7 may be omitted in different applications. The entire system shown in FIG. 7 is controlled by computer readable instructions that are usually stored as software in hard disc 751, EPROM or other non-volatile memory. The software may be downloaded from a network (not shown in the figure) or stored in hard disc 751. The software downloaded from a network may be uploaded to RAM 720 and executed by processing unit 710, so as to perform the function determined by the software.

The present invention may further be implemented as a file editor used by, for example the computer system shown in FIG. 7, which may implement the copy and/or paste method of the present invention.

It should be noted that in order to facilitate easier understanding of the present invention, the foregoing description omits more detailed technical details that are well known to those skilled in the art and might be indispensable to the implementation of the present invention.

The specification of the present invention has been presented for purposes of illustration and description, and is not intended to be exhaustive or limited to the invention in the form disclosed. Many modifications and variations will be apparent to those of ordinary skill in the art.

Therefore, the embodiments were chosen and described in order to best explain the principles of the invention and the practical application. Those of ordinary skill in the art will understand that all modifications and alterations made without departing from the spirit of the present invention fall into the protection scope of the present invention as defined in the appended claims.

1. A method of copying a data object, comprising the steps of:
selecting a data object from a file;
in response to that there is an original data object corresponding to the data object in the file, writing the data object to the clipboard or writing the original data object to the clipboard at least responsive to the selection of a user, wherein the original data object is mapped to the data object as implicit data of the file.

2. The method according to claim 1, further comprising the step of:
in response to that there is no original data object corresponding to the data object in the file, writing the data object to the clipboard.

3. The method according to claim 1, wherein:
in the file, each data object has a property uniquely identifying the ID of its original data object information, and in response to that the data object has no corresponding original data object, the property value is NULL;
the implicit data of the file is mapped to the data object by using a map table;
the original data object is mapped to the data object via the ID in the map table.

4. The method according to claim 3, further comprising the step of:
looking up the ID indicated by the property of the data object in the map table in order to obtain the original data object information.

5. The method according to claim 3, wherein:
during editing a data object in the file, an item corresponding to the data object in the map table is updated according to a certain policy.

6. A method of pasting a data object, comprising the steps of:
archiving a data object in a clipboard as an original data object;
filtering the data object in order to make it conform to the format and/or functionality requirement of a file;
explicitly writing the filtered data object to the file, and implicitly writing the original data object to the file,
wherein the original data object is mapped to the data object as implicit data of the file.

7. The method according to claim 6, wherein:
in the file, each data object has a property uniquely identifying the ID of its original data object information, and in response to that the data object has no corresponding original data object, the property value is NULL;
the implicit data of the file is mapped to the data object by using a map table;
the original data object is mapped to the data object via the ID in the map table.

8. The method according to claim 7, wherein:
during editing a data object in the file, an item corresponding to the data object in the map table is updated according to a certain policy.

9. A file editor, for implementing a method comprising the steps of:
selecting a data object from a file;
in response to that there is an original data object corresponding to the data object in the file, writing the data object to the clipboard or writing the original data object to the clipboard at least responsive to the selection of a user, wherein the original data object is mapped to the data object as implicit data of the file.
